(19) United States
(12) Patent Application Publication
(10) Pub. No.: US 2024/0367742 A1
(43) Pub. Date: Nov. 7, 2024

(54) SIGNALLING DEVICE FOR BICYCLES

(71) Applicant: DRAISLER VENTURES, S.L., Madrid (ES)

(72) Inventors: Jesús SANZ ESPINOSA, Madrid (ES); José Manuel PASTOR GONZALEZ DEL VAL, Madrid (ES)

(73) Assignee: DRAISLER VENTURES, S.L., Madrid (ES)

(21) Appl. No.: 18/692,380

(22) PCT Filed: Sep. 15, 2021
(86) PCT No.: PCT/ES2021/070662

§ 371 Date: Mar. 15, 2024

(51) Int. Cl. B62J 6/26; B62J 6/01; B62J 6/045; B62J 6/056; F21S 43/14; F21S 43/19; F21S 45/50; F21W 103/20; F21W 103/35; F21W 103/60; F21Y 113/20; F21Y 115/10; F21Y 115/30

(52) U.S. Cl. CPC B62J 6/26; B62J 6/01; B62J 6/045; B62J 6/056; F21S 43/14; F21S 43/19; F21S 45/50; F21W 2103/20; F21W 2103/35; F21W 2103/60; F21Y 2113/20; F21Y 2115/10; F21Y 2115/30

(57) ABSTRACT

A signalling device for bicycles comprising a lighting unit connectable to a support on the vehicle, which includes signalling lights, brake lights and turn signals, and for delimiting a reference safety distance for other vehicles; formed by a central body, which includes the electronics and signalling systems enclosed therein and isolated from the weather, and two horizontal arms, diametrically opposed, arranged so that at least one of them is foldable on the previous one and both are shaped to internally transmit the light from two LEDs that provide the turn signal to the bicycle to the ends, which are separated from each other by at least 18 cm.

### TECHNICAL FIELD

The present invention falls within the technical field of optical signalling or lighting devices for bicycles (B62J27/00). More specifically, in devices with rear lights, turn signals, brake lights and signalling lights for the safety distance that other vehicles must keep from the cyclist.

### STATE OF THE ART

In the current state of the art, a wide variety of lighting devices for signalling vehicles and especially for use on bicycles are known. The functions of these devices vary, with the fundamental ones being: A warning light, usually consisting of a flashing red light with a variety of effects, a brake light, turn signals and laser projections around the bicycle.

The warning light is usually based on the flashing of a normally red light with a variety of effects. These effects do not have a technical criterion and also increase the complexity of using the device. In many cases, the light produced has a low intensity and is not clearly perceived at a certain distance.

Brake lights are known to be manually operated by pressing a button, which makes them dangerous when releasing a hand to perform braking. There are also automatic brake lights, either with accelerometers and different braking detection algorithms, or wired to the brake controls, which complicates installation.

Finally, laser projections tend to be unsuitable either due to their geometry or due to the distance from the bicycle to those that are projected. Circular lenses are usually used to generate the line effect, this solution making it difficult to assemble the equipment since it requires correct orientation of the lens.

For example, document WO2018157923 (A1) describes an integral lighting and safety device for bicycles that comprises a plurality of light sources to indicate the position of a bicycle and/or a change in its direction, and a laser module further comprising a laser source housed in a crosswise housing, and a single line lens having a grooved side, housed in the lower window and positioned with respect to the laser source in such a way that, when an emitted light from the laser source reaches the line lens, a beam having a circumference arc shape, with an arc between 240° and 60°, is projected from the line lens with the aim of delimiting a safety space around the rear of the bicycle.

The aforementioned document, like most known devices, is small in size, making it extremely difficult to distinguish which side of the turn signal is active until one is very close to the cyclist. There are some models where this separation is greater, but if the device is removed, its size is bulky to carry around.

Therefore, the need arises for a lighting and signalling device that ensures visibility of the cyclist at a distance that allows the driver to react without danger, that activates the brake light without user intervention when speed is reduced, that marks a safety zone for the cyclist in accordance with the rules of traffic regulations, that can be placed on and removed from the vehicle, and is easy to transport.

Furthermore, the control unit must be used without taking one's hands off the handlebar, it may be installed on both sides for right- and left-handed use, and it must not interfere with the use of other elements such as brake levers or shift levers.

### DESCRIPTION OF THE INVENTION

To achieve the proposed objectives mentioned in the previous section, the invention proposes a signalling device for bicycles, formed by a lighting unit and a remote control unit designed to overcome the aforementioned drawbacks, and having the features of claim 1.

The lighting unit has an anchoring area for anchoring to a support placed on the vehicle, which enables it to be installed and removed in a simple and reliable way. The charging connector is arranged in this anchoring area so that once installed it is protected from the weather.

The lighting unit, towards the rear, consists of several LEDs that flash at a fixed frequency close to 1 Hz that human vision perceives quickly. They also provide a high light intensity so that they are visible more than 500 metres away. Internally, there is an accelerometer that steadily activates the rear LEDs at maximum intensity, indicating that the bicycle is braking. To achieve this, the algorithm eliminates the effects of gravity produced by ramps and descents, as well as induced vibrations.

Internally and on both sides, the lighting unit has laser emitters that project lines onto the road at a safe distance as a reference for vehicles. These lines pass through the transparent material that this unit is made of. The laser diode emits a point that therefore has no orientation, and it is mounted on a support that incorporates a lens in its geometry, which simplifies assembly since the support is a single piece with mounting that orients the line.

This lighting unit, also located internally and on both sides, has LED diodes that emit two blinking light beams, which pass through the transparent body of the unit and are projected at the end of the corresponding side arm of the unit. These arms are arranged so that at least one of them is foldable, so that once one is folded over the other their size is essentially reduced by half. Both the shape, length and reflective parts of these arms can be modified without affecting the internal portion of the unit, so that a wide variety of models for said arms may be available. Preferably, when the arms are opened, there is locking by bending an area of the arm which requires a certain level of effort for them to change position.

This lighting unit has a central body, which includes the aforementioned electronics and signalling systems: laser lines, turn signals and signalling and brake lights, enclosed therein and isolated from the weather, avoids the use of displays or extra transparent parts, and in the case of the turn signals, eliminates wiring and connections, which reduces costs, simplifies the folding of the arms and allows said arms to adopt a length that allows the separation between the two turn signals at the distance established for other similar vehicles, for example, a motorcycle.

The control for said lighting unit is fixed to the handlebar of the bicycle and its arrangement is such that it allows access to the buttons without taking one's hand off the handlebar. To achieve this, the control has on one of its sides a support in the form of a narrow flange that can be inserted between the different elements on the handlebar (grip, lever, gear, etc.). This arrangement leaves most of the control cantilevered, being able to be oriented in both directions to keep the buttons always close to the grip. Furthermore, the fixing flange leaves the control at a certain height from the handlebar, allowing the flanges of other components (brake, gear, etc.) to be below it. The flange allows the control to be rotated to find the most comfortable orientation, to have a better view of the control and not hide displays such as that of the gear position. By using a function, the operation can be reversed so that it can be placed on both sides of the handlebar and in any orientation.

This control communicates wirelessly with the lighting unit, allowing it to indicate a right or left-hand turn. The turn signal turns off automatically, avoiding having to press the control again. A short or long press can be made so that the duration of the turn signal is different.

One of the main objectives of the present invention is to provide a device that ensures the visibility of the cyclist at a distance that allows the driver to react without danger, that activates the brake light without user intervention when speed is reduced, and that marks a safety zone for the cyclist in accordance with the rules of traffic regulations.

Another objective of the present invention is to provide a device that can be easily placed on and removed from the vehicle and that can be folded for easy transport.

Another objective of this invention is to provide a device of this type that is affordable to implement and maintain and that retains its effectiveness over time.

Other objectives of the invention will be disclosed in the following detailed description of an exemplary embodiment which has the purpose of making the invention completely known without limiting same.

### DESCRIPTION OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows a view of a bicycle in which the brake light (S1), turn signal (S2) and safety area delimitation signal (S3) have been represented.

FIG. 2 show the lighting unit (2) in the following views:
FIG. 2a, side elevation.
FIG. 2b, top plan.
FIG. 2c, rear elevation.
FIG. 2d, cross section through a horizontal plane.
FIG. 2e, cross section through a vertical plane, with the lens that projects the lines (S3) on both sides of the bicycle (1) being mounted on the support of the laser.
FIG. 2f, an inner view of the body (22) showing the window (24) in which a lens that projects the lines (S3) on both sides of the bicycle (1) is formed.
FIG. 2g, rear elevation in a position of use.
FIG. 2h, rear elevation with the arms (23) folded.

FIG. 3 show the control unit (3) in the following views:
FIG. 3a, front elevation.
FIG. 3b, top plan.
FIG. 3c, side elevation.

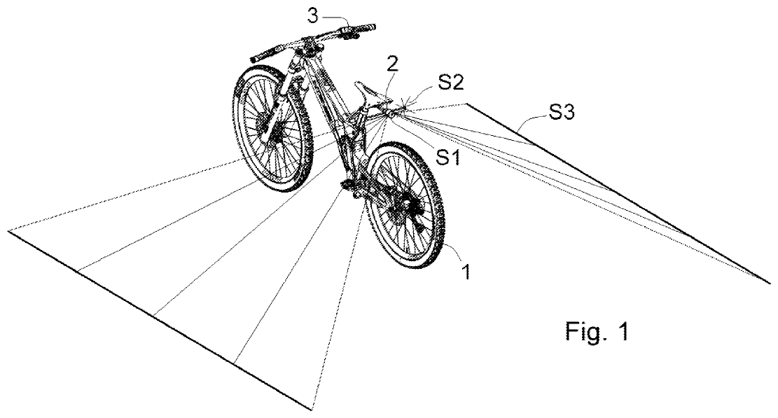

### EMBODIMENT OF THE INVENTION

As shown in the referenced figures, the invention relates to a signalling device for bicycles, which comprises:
A lighting unit (2) provided with fixing and support means (21) on the vehicle, which includes several lighting systems:
   (S1) several LEDs that flash towards the rear signalling the position of the bicycle, or that turn on steadily when the bicycle is braking.
   (S2) LED diodes that emit two blinking light beams towards the side and rear of the vehicle.
   (S3) laser emitters (30) that project lines onto the road at a safe distance as a reference for other vehicles, towards both sides of the bicycle.
A control unit (3), fixed to the handlebar of the bicycle and wirelessly connected to the lighting unit (2), by means of which the cyclist signals their intention to turn left or right by using two buttons (31, 32) located thereon.

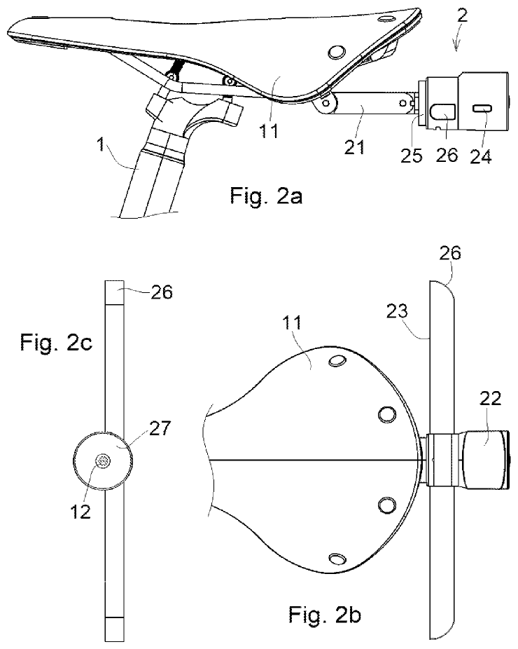

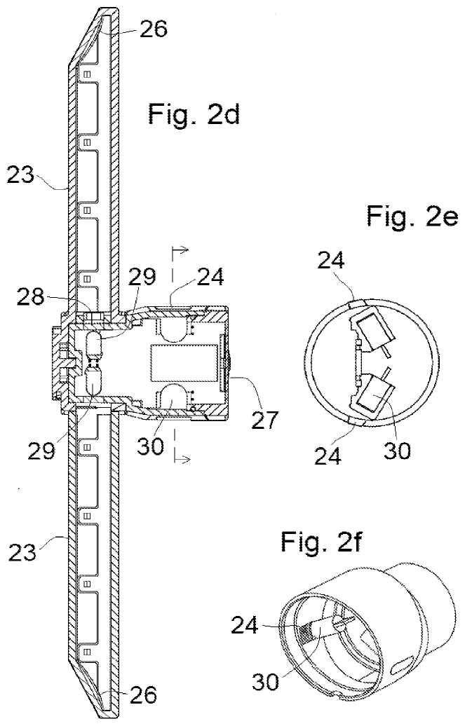

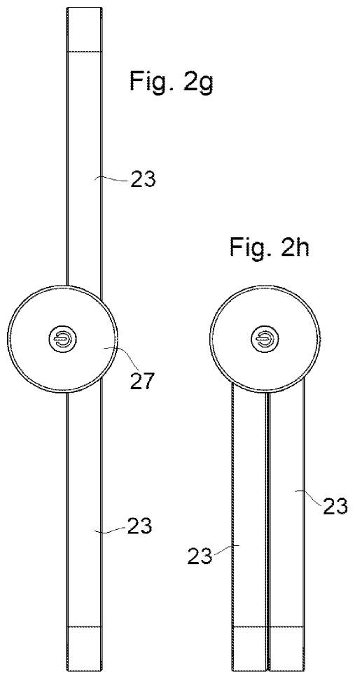

The lighting unit (2), represented in FIGS. 2, is made up of a central body (22), which includes the electronics and signalling systems enclosed therein and isolated from the weather, from which two horizontal arms (23) emerge, diametrically opposed, arranged so that at least one of them is foldable on the other, leaving the central body (22) on one side. At the free end, both have the corresponding turn signals, which are separated from each other by at least 18 cm, which is the minimum regulatory distance at which these lights must be placed on a motorcycle so that there are no doubts about their signalling to other vehicles.

As already indicated, a special feature of this lighting unit is that, on the one hand, there is a great length from end to end, measured along the arms (23), and yet all the lighting systems indicated previously are enclosed in the central body (22) in a sealed manner. To achieve this objective, it is necessary for this central body (22) to be transparent at least in several areas:
In two side windows (24) through which the beam of two laser diodes (30) that project two lines (S3) onto the ground exits, on both sides of the bicycle (1). These laser diodes (30) point to two lenses that can be mounted or formed on the support of said laser diodes (FIG. 2e), or on the central body (22) (FIG. 2f).
In the rear area (27), which is illuminated by LEDs that flash to signal the position of the bicycle (1) or that turn on steadily while the bicycle is braking. These lines pass through the transparent material that this unit is made of.
And in two side areas (28), located in correspondence with the interior of the respective arms (23), which transmit the light from two blinking LED diodes (29) to the ends of said arms. In a preferential embodiment, two reflectors (26) help to project the blinking light towards the sides and the rear area of the lighting unit (2).

The central body (22) of the lighting unit (2) further comprises a battery that powers the internal electronics, which is charged through a USB-type connection (25) or similar, and an on/off switch (12), which is preferably located in the centre of the tail light (27).

The electronics that control the signalling systems included in the central body (22) of the lighting unit (2) provides for turning on the turn signals for a predefined period of time after the cyclist activates the corresponding button (31, 32), so that they do not have to activate the button twice. On the other hand, the turning on of the LEDs that flash in the rear (27) signalling the presence of the bicycle becomes steady when an accelerometer included in said lighting unit (2) detects that the bicycle is braking. In a preferential embodiment, the algorithm based on which the brake light is turned on provides for eliminating the effects of gravity produced by ramps and descents, as well as due to induced vibrations.

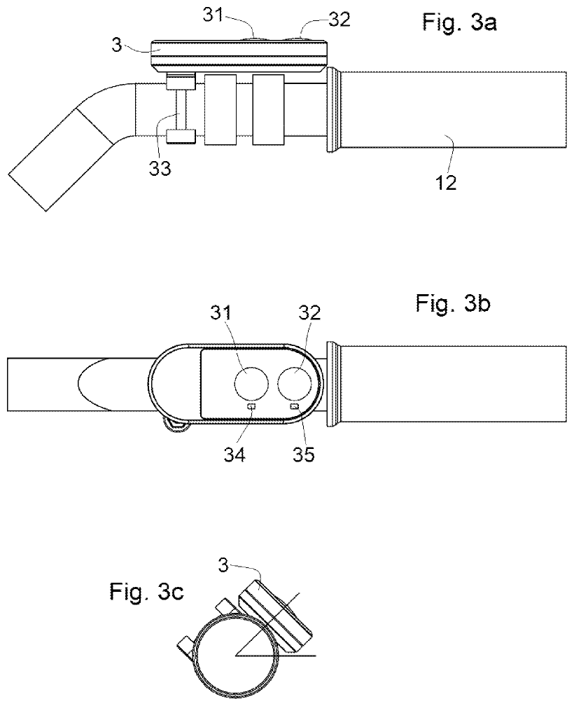

The control (3), represented in FIGS. 3, comprises a housing that includes electronics having wireless communication means with the lighting unit (2), through which the intention to turn right or left is indicated by means of two buttons (31, 32). Optionally, the operation of the turn signals of the lighting unit (2) is also signalled on two lights (34, 35).

This control (3) is fastened on the handlebar (12) of the bicycle by means of a clamp (33) that includes a ball joint enabling the control (3) to be rotated based on the needs of the cyclist; as shown in FIG. 3c, the control is generally placed turned towards the cyclist and at a certain angle backwards so that they can easily see which button they have to press at least while they are getting used to using the device. This clamp (33) is preferably arranged at one of the ends of said control, leaving the main portion of the same cantilevered and raised slightly above the handlebar in order to leave space for other bicycle gear or brake flanges located on the same area of the handlebar. Furthermore, this clamp (33) can be fixed at either end of said control.

The control (3) can be mounted either on the left side or on the right side of the handlebar, whereby the turn signal turned on by each button can be exchanged by means of an action on the buttons (31, 32).

Having described the nature of the invention, as well as a preferred exemplary embodiment, it is obvious that the invention is industrially applicable in the indicated sector.

Likewise, it is hereby stated for all appropriate purposes that the materials, shape, size, and arrangement of the described elements can be modified, provided that this does not entail altering the essential features of the invention claimed below:

1. A signalling device for bicycles, the signalling device comprising:
a lighting unit connectable to a support on a vehicle, which includes:
several LEDs that flash towards a rear or that turn on steadily when a bicycle is braking;
on both sides, laser emitters that project lines onto a road at a safe distance as a reference for other vehicles; and
on both sides, LED diodes that emit two blinking light beams;
a control unit, fixed to a handlebar of the bicycle and wirelessly connected to the lighting unit, wherein
the lighting unit comprises:
a) a central body, which includes electronics and signalling systems enclosed therein and isolated from weather, which is transparent at least in:
two side windows through which a beam of two laser diodes which when passing through a lens project two lines onto the ground exits on both sides of the bicycle;
a rear area (27), which is illuminated by LEDs that signal a position of the bicycle or that the bicycle is braking; and
two side areas in correspondence with an interior of two arms that transmit light from two blinking LED diodes projecting the light from turn signals towards sides and/or a rear area of the lighting unit; and
b) two horizontal arms, diametrically opposed, arranged so that at least one of said two horizontal arms is foldable on a previous one of said two horizontal arms and both of said two horizontal arms are hollow and shaped to internally transmit the light from two LEDs that provide the turn signal lights towards the sides and the rear area of the lighting unit, said turn signals being at least 18 cm apart from each other.

2. The device, according to claim 1, wherein the control (3) comprises:
a housing that includes electronics having wireless communication means with the lighting unit, through which an intention to turn right or left is indicated;
at least two buttons respectively for both turn signals;
a clamp for fastening on the handlebar of the bicycle, which includes a ball joint enabling the control to be rotated based on a needs of a cyclist.

3. The device, according to claim 1, wherein the central body of the lighting unit further comprises:
fixing means for fixing the same on the bicycle;
a connection for charging an internal battery that powers said device; and
an on/off switch.

4. The device, according to claim 2, wherein the signalling systems included in the central body of the lighting unit provide for turning on the turn signals for a predefined period of time after the cyclist activates a corresponding button of said at least two buttons.

5. The device, according to claim 4, wherein the turn signal turned on by each button can be exchanged by means of an action on the at least two buttons.

6. The device, according to claim 1, wherein the signalling systems included in the central body of the lighting unit provide for turning on the LEDs that flash in the rear signalling the presence of the bicycle, steadily when an accelerometer included in said lighting unit detects that the bicycle is braking.

7. The device, according to claim 1, wherein the lenses that project the two lines onto the ground on both sides of the bicycle are mounted or formed on the support of said laser diodes, or on the central body of the lighting unit.

8. The device, according to claim 2, wherein the clamp for fastening the control is arranged at one of the ends of said control, leaving the main portion of the same cantilevered and raised slightly above the handlebar in order to leave space for other components located on the same.

9. The device, according to claim 8, wherein the clamp for fastening the control can be fixed at either end of said control.
